(19) United States
(12) Patent Application Publication
(10) Pub. No.: US 2010/0067237 A1
(43) Pub. Date: Mar. 18, 2010

(54) LIGHT SOURCE DEVICE

(75) Inventors: Takahide Nishimura, Kanagawa (JP); Takashi Uchino, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/359,886

(22) Filed: Jan. 26, 2009

(30) Foreign Application Priority Data
Sep. 16, 2008 (JP) 2008-236673

(51) Int. Cl. F21V 29/00

(52) U.S. Cl. 362/294

(57) ABSTRACT

A light source device, includes: a light emitting source; a cooling portion to feed a cooling air for cooling the light emitting source; a duct comprising an inflow opening through which the cooling air inflows; and a separating portion installed in the duct, and being adapted to separate the duct and form an opening for front portion through which the cooling air blows out to the front portion of light emitting source and an opening for rear portion through which the cooling air blows out to the rear portion of light emitting source.

The present application is based on Japanese patent application No. 2008-236673, the entire contents of which are incorporated herein by reference.

### BACKGROUND

1. Field

One embodiment of the invention relates to a light source device.

2. Description of the Related Art

As conventional technology, there has been known a projector including a lamp having a light emitting source to emit a light, a reflector to reflect the light emitted from the light emitting source, a cover glass to cover the emission surface of the light from the reflector, a cooling means disposed outside the reflector, and an air flow direction changing means disposed within a space surrounded by the reflector and the cover glass and outside the emitted light path of the light reflected by the reflector and which changes the direction of cooling air from the cooling means (for example, refer to JP 2005-234523 A1).

According to the projector, the flow direction of the cooling air fed from the cooling fan as the cooling means is changed by the air flow direction changing means to the direction of the light emitting source so that the light emitting source can be cooled.

However, there is a problem that the conventional projector is operable to cool the light emitting source of lamp, but not to cool the rear portion of lamp so that it can not cool the lamp efficiently.

Further, there is a problem that the conventional projector can not cool the lamp efficiently and the number of rotations of cooling fan can not help increasing so that the electric power consumption is increased and the operating noise is enlarged.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic view showing a projector using a light source device according to a first embodiment of the invention;

FIG. 2 is a cross-sectional view showing a light source device according to a first embodiment of the invention;

FIG. 3 is a cross-sectional view showing a lamp used in a light source device according to a first embodiment of the invention;

FIG. 4 is a cross-sectional view taken along the line A-A in FIG. 3 showing a lamp used in a light source device according to a first embodiment of the invention;

FIG. 5 is a schematic view showing a duct used in a light source device according to a first embodiment of the invention;

FIG. 6 is a plan view showing a light source device according to a first embodiment of the invention;

FIG. 7 is a schematic view showing a duct used in a light source device according to a second embodiment of the invention;

FIG. 8 is a schematic view showing a duct used in a light source device according to a third embodiment of the invention.

### DETAILED DESCRIPTION OF PREFERRED EMBODIMENTS

Various embodiments according to the invention will be described hereinafter with reference to the accompanying drawings.

(1) According to one embodiment of the invention, there is provided a light source device, includes:

a light emitting source;

a cooling portion to feed a cooling air for cooling the light emitting source;

a duct comprising an inflow opening through which the cooling air inflows; and

a separating portion installed in the duct and being adapted to separate the duct and form an opening for front portion through which the cooling air blows out to the front portion of light emitting source and an opening for rear portion through which the cooling air blows out to the rear portion of light emitting source.

In the above invention (1), the following modifications and changes can be made.

(i) The light emitting source comprises a light emitting portion to emit a light, and a reflecting mirror installed so as to enclose the light emitting portion and reflect the light emitted from the light emitting portion in the direction of the light axis, and the opening for front portion is adapted to allow the cooling air to blows out through the opening so as to cool the light emitting portion.

(ii) The light emitting source comprises a mercury lamp.

(iii) The separating portion comprises an extension portion extending in the direction of the cooling air inflowing, and a changing portion installed at the end of the extension portion so as to change the direction of the cooling air which flows along the extension portion.

(iv) The changing portion comprises an adjusting opening to adjust the volume of cooling air to blow out through the opening for front portion and the place of light emitting portion to be cooled.

(v) The cooling portion is located at the lateral part of, and in a position anterior to the light emitting source, and the changing portion is adapted to change the direction of the cooling air fed from the cooling portion to the direction of light emitting portion enclosed by the reflecting mirror.

(vi) The changing portion is adapted to change the direction of the cooling air so as to cool the highest temperature point and the lowest temperature point of the light emitting portion.

(vii) The changing portion is adapted to adjust the cooling air blowing out to the highest temperature point and the lowest temperature point by the adjusting opening.

(viii) The separating portion comprises an attaching portion for being attached to the duct.

(ix) The separating portion comprises a metallic material.

(x) The cooling portion comprises an electric-powered fan.

(xi) The light source device is adapted to be mounted on a projector to project picture images onto a screen.

(2) According to a further embodiment of the invention, there is provided a light source device, includes:

a light emitting source comprising a light emitting portion to emit a light, and a reflecting mirror installed so as to enclose the light emitting portion and reflect the light emitted from the light emitting portion in the direction of the light axis;

an electric-powered fan being located at the lateral part of, and in a position anterior to the light emitting source, and being adapted to feed a cooling air for cooling the light emitting source;

a duct comprising an inflow opening through which the cooling air inflows, and

a separating portion installed in the duct, being adapted to separate the duct and form an opening for front portion through which the cooling air blows out so as to cool the light emitting portion from the front portion of light emitting source and an opening for rear portion through which the cooling air blows out so as to cool the reflecting mirror and the rear portion of light emitting source, and comprising an extension portion extending in the direction of the cooling air inflowing, and a changing portion installed at the end of the extension portion so as to change the direction of the cooling air which flows along the extension portion.

In the above invention (2), the following modifications and changes can be made.

(xii) The light emitting source comprises a mercury lamp.

(xiii) The changing portion comprises an adjusting opening to adjust the volume of cooling air to blow out through the opening for front portion and the place of light emitting portion to be cooled.

(xiv) The changing portion is adapted to adjust the cooling air blowing out to the highest temperature point and the lowest temperature point by the adjusting opening.

(xv) The changing portion is adapted to change the direction of the cooling air so as to cool the highest temperature point and the lowest temperature point of the light emitting portion.

(xvi) The separating portion comprises an attaching portion for being attached to the duct.

(xvii) The separating portion comprises a metallic material.

(xviii) The light source device is adapted to be mounted on a projector to project picture images onto a screen.

### ADVANTAGE OF THE INVENTION

According to a light source device of the invention, a light emitting source is efficiently cooled so that the electric power consumption can be decreased and the operating noise can be lowered.

Hereinafter, a light source device according to an embodiment of the invention will be described in detail with reference to the accompanying drawings.

### First Embodiment

### (Construction of Projector)

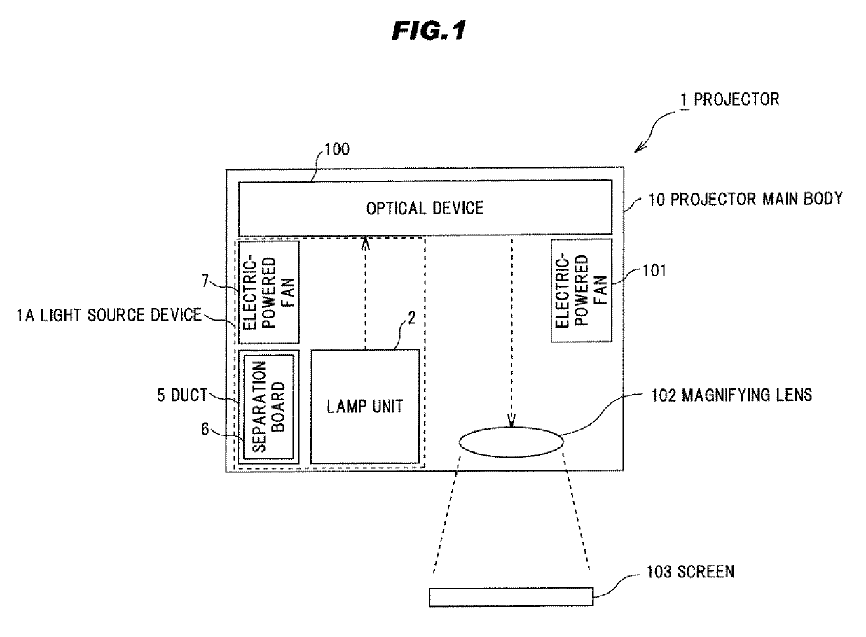

FIG. 1 is a schematic view showing a projector using a light source device according to a first embodiment of the invention. Hereinafter, an embodiment that a light source device according to the invention is mounted on a projector will be described.

As shown in FIG. 1, the projector 1 has, as one example, an outline of structure that includes a projector main body 10, a lamp unit 2, a duct 5, an electric-powered fan 7, an optical device 100, an electric-powered fan 101 and a magnifying lens 102. The electric-powered fan 101 is used for cooling the inside of the projector main body 10.

Further, in the projector 1, as one example, when a light emitted from the lamp unit 2 enters the optical device 100, the optical device 100 splits the light into three primary colors of RGB by lens and color filters (not shown), controls the gradation of RGB in the split light according to image signals inputted from the outside, and emits the controlled light to the magnifying lens 102. The emitted light is magnified and projected on a screen by the magnifying lens 102. Further, the structure of the projector 1 is not particularly limited in the above-mentioned structure, and a well-known projector can also be used.

### (Construction of Light Source Device)

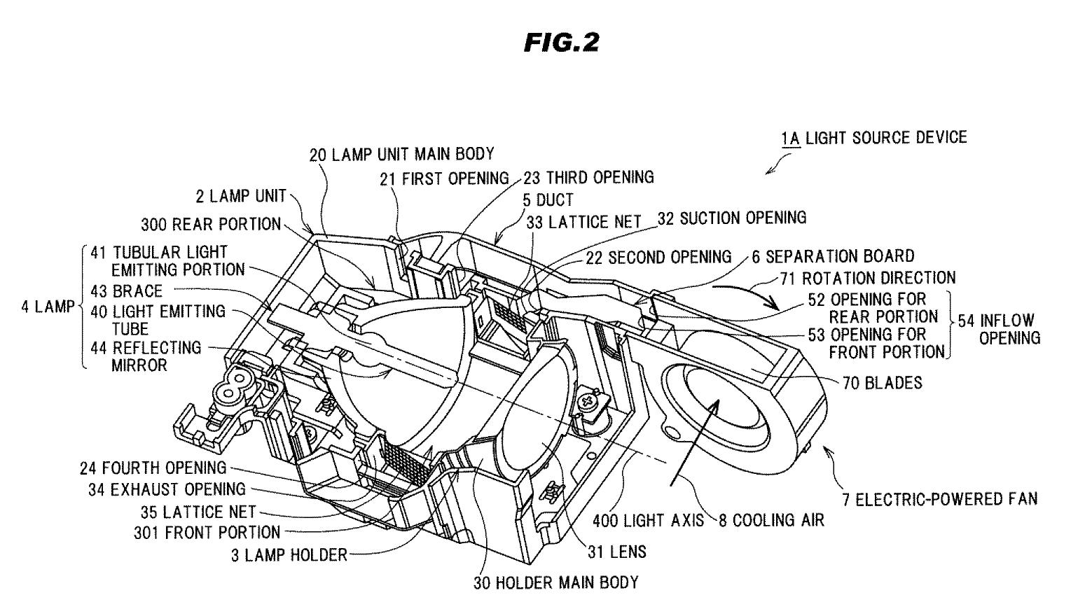

FIG. 2 is a cross-sectional view showing a light source device according to a first embodiment of the invention. FIG. 2 shows a cross-section when a part relating to the light source device is cut in a horizontal direction to the installation surface.

As shown in FIG. 2, the light source device 1A to be mounted on the projector 1 has an outline of structure that includes a lamp (a light emitting source) 4 held by a lamp holder 3, a duct 5 disposed on the side surface of the lamp unit 2, a separation board (a separating portion) 6 disposed in the duct 5 and an electric-powered fan (a cooling portion) 7 to feed a cooling air 8 to the duct 5.

### (Construction of Lamp Unit)

The lamp unit 2 has, as one example, a lamp unit main body 20 formed from a plastic material, a first opening 21, a second opening 22 and a third opening 23 formed in the side surface of the lamp unit main body 20 on which the duct 5 is installed, and a fourth opening 24 formed in the side surface of the lamp unit main body 20 which faces to the first, second and third openings 21, 22 and 23, and the lamp unit main body 20 has a structure that the lamp holder 3 is inserted thereinto and the lamp holder 3 inserted is held. Further, the lamp 4 can be disposed in the lamp unit 2 directly.

As shown in FIG. 2, the first and third openings 21, 23 are formed in the side surface of the lamp unit main body 20 according to the rear portion 300 of the lamp holder 3, the first opening 21 is adapted to lead the cooling air 8 to neighborhood of a brace 43 of the lamp 4, and the third opening 23 is adapted to lead the cooling air 8 to back side of the reflecting mirror 44 of the lamp 4.

The second opening 22 is formed in the front portion of the lamp 4, in other words, in the side surface of the lamp unit main body 20 according to the front portion 301 formed by the lamp 4 and the lens 31, and is adapted to lead the cooling air 8 to a light emitting tube 40 from the front portion of the lamp 4.

The fourth opening 24 is formed in the side surface of the lamp unit main body 20 which faces to the second opening 22, and is adapted to exhaust the cooling air 8 led to the front portion 301.

### (Construction of Lamp Holder)

As shown in FIG. 2, the lamp holder 3 has an outline structure that includes a holder main body 30, a lens 31 installed in the front portion of the lamp 4, a suction opening 32 formed in the side surface of the holder main body 30 according to the second opening 22, a lattice net 33 installed on the suction opening 32, an exhaust opening 34 formed in the side surface of the holder main body 30 according to the fourth opening 24, and a lattice net 35 formed on the exhaust opening 34.

As shown in FIG. 2, the suction opening 32 is disposed in a position anterior to the margin of front surface of the reflecting mirror 44. This is an effort to efficiently reflect the light emitted from the lamp 4 in a direction of the light axis 400 by the reflecting mirror 44. Further, the exhaust opening 34 is also disposed in a position anterior to the margin of front surface of the reflecting mirror 44 for a similar reason.

The lattice nets 33, 35 are formed in a plate-like shape where openings are arranged in a net-like shape by a metallic material, have a structure that does not obstruct the suction and exhaust of the cooling air 8, and further, are installed in the lamp holder 3, for example when the lamp 4 bursts, so as to prevent broken pieces from flying.

### (Construction of Lamp)

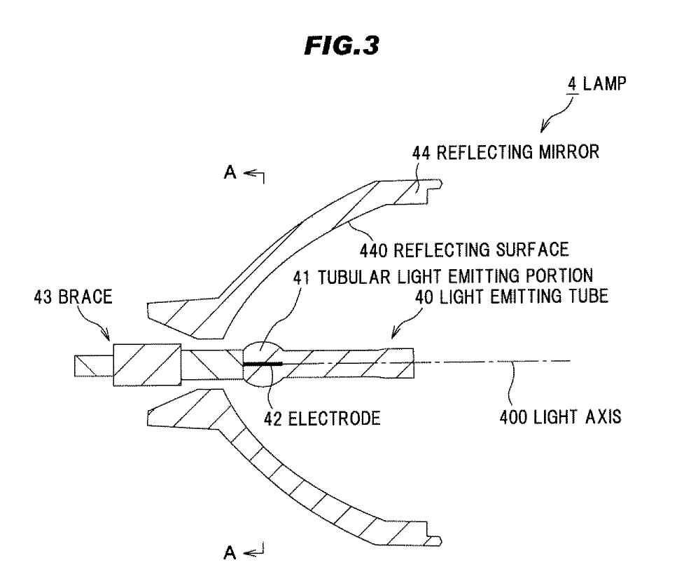

FIG. 3 is a cross-sectional view showing a lamp used in a light source device according to a first embodiment of the invention. The lamp 4 is, as one example, a high-pressure mercury lamp, and has an outline of structure that includes the light emitting tube 40 in which mercury and rare gases are encapsulated, a tubular light emitting portion 41 having a spherical shape, formed around an electrode 42 disposed in the light emitting tube 40, the electrode 42 disposed in the light emitting tube 40, a brace 43 formed at an end portion of the light emitting tube 40 so as to be held by the holder main body 30 and be connected to an outside electric power supply, and the reflecting mirror 44 having a reflecting surface 440 in the inner surface of almost conical shape to surround the light emitting tube 40.

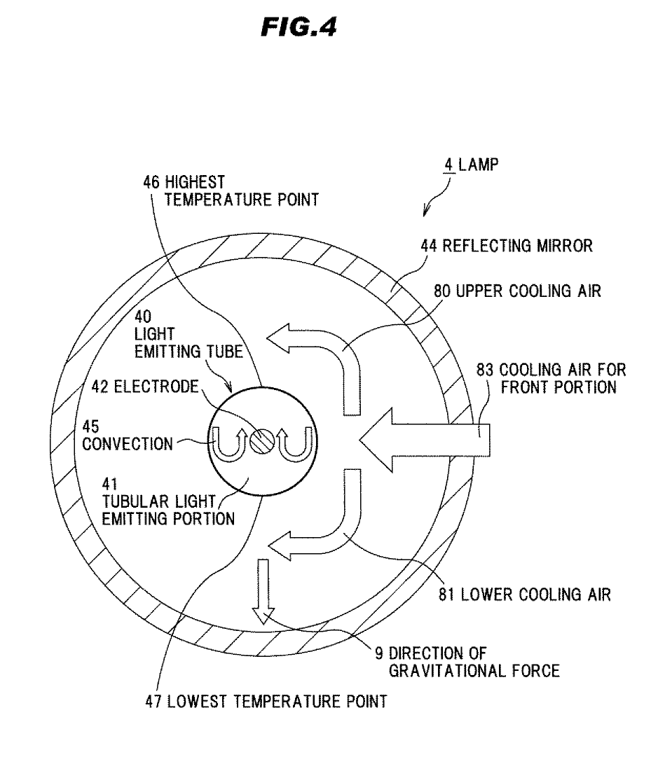

FIG. 4 is a cross-sectional view taken along the line A-A in FIG. 3 showing a lamp used in a light source device according to a first embodiment of the invention. As shown in FIG. 4, in the lamp 4, the mercury encapsulated in the light emitting tube 40 evaporates in accordance with increase of temperature of the electrode 42 due to electric power distribution, and performs natural convection as convection 45 in the light emitting tube 40 by an influence of gravitational force. At this time, the interior temperature of the light emitting tube 40 rises to almost 2000 to 3000 degrees C.

In the projector 1, the lamp 4 is designed about temperature by regarding a condition of being placed on a desk or a ceiling horizontally as a basic condition. The lamp 4 is designed about temperature based on an upper limit and a lower limit in the tubular light emitting portion 41.

The upper limit is determined based on allowable temperature limit of silica glass constituting the light emitting tube 40, the lower limit is determined so as to make halogen cycle in the light emitting tube 40 appropriate, the halogen cycle affecting the life of the lamp 4, and as one example, the upper limit is set to 1000 degrees C. and the lower limit is set to 900 degrees C.

As shown in FIG. 4 as one example, the tubular light emitting portion 41 reaches the highest temperature point 46 corresponding to the highest temperature of the light emitting tube 40 at the top of the light emitting tube 40 by the convection 45 based on the direction of gravitational force 9, and reaches the lowest temperature point 47 corresponding to the lowest temperature of the light emitting tube 40 at the bottom of the light emitting tube 40.

As shown in FIG. 4, when a cooling air for front portion 83 described below blows out from right to left in the drawing, the cooling air for front portion 83 mainly encounters the tubular light emitting portion 41 so as to be divided into an upper cooling air 80 and a lower cooling air 81, and the upper cooling air 80 can cool the highest temperature point 46 and the lower cooling air 81 can cool the lowest temperature point 47. The projector 1 can obtain the desired upper and lower limits by adjusting the cooling air for front portion 83.

### (Construction of Duct)

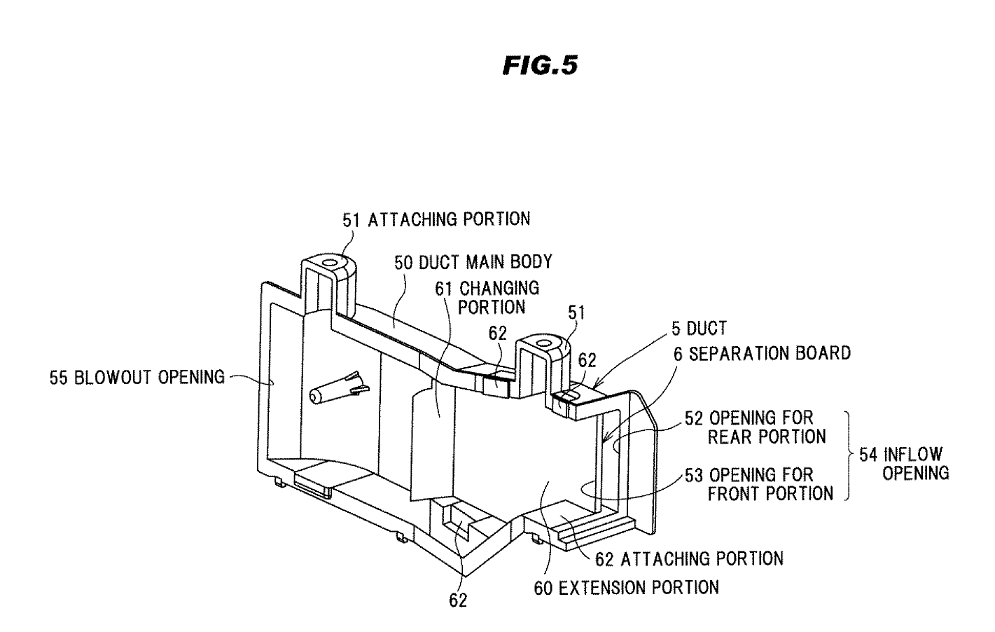

FIG. 5 is a schematic view showing a duct used in a light source device according to a first embodiment of the invention. As shown in FIG. 5, the duct 5 has an outline of structure that includes a duct main body 50 formed from a plastic material in a rectangular pipe shape and having a shape that one of side surfaces in a longitudinal direction is open, two attaching portions 51 disposed on the upper portion of the duct main body 50 for being inserted into predetermined members of the lamp unit main body 20 so that the duct 5 can be connected to the lamp unit main body 20, an opening for rear portion 52 as an opening formed by being separated with a separation board 6 described below, an opening for front portion 53 as an opening formed by being separated with the separation board 6, an inflow opening 54 as an opening formed before being separated with an extension portion 60 of the separation board 6, and a blowout opening 55 as an opening formed before being separated with a changing portion 61 of the separation board 6.

The blowout opening 55 is divided by the changing portion 61 of the separation board 6 into two openings. Of the two openings, one faces to the first and third openings 21, 23 formed in the side surface of the lamp unit main body 20 as openings for rear portion and another faces to the second opening 22 formed as openings for front portion. Further, the first to third openings 21 to 23 can be disposed in the side of the duct 5.

### (Construction of Separation Board)

The separation board 6 is, as one example, formed of a metallic board as a whole, and as shown in FIG. 5 has an outline of structure that includes the extension portion 60, the changing portion 61 and attaching portions 62.

As shown in FIG. 5, the extension portion 60 has a structure that extends in a longitudinal direction of the duct 5, in other words, extends along the flow direction of the cooling air 8 fed from the electric-powered fan 7, and by the structure, the cooling air 8 being fed blows out from each opening, being increased in the wind speed inside of the separated inside. The inflow opening 54 is separated by the extension portion 60 into the opening for rear portion 52 and the opening for front portion 53.

As shown in FIG. 5, the changing portion 61 is disposed at the end of the extension portion 60 and inclines to the side of the lamp unit 2 for the extension portion 60. The flow direction of the cooling air 8 fed from the opening for front portion 53 is changed, approximately maintaining the wind speed increased by the changing portion 61.

As shown in FIG. 5, the attaching portions 62 are disposed two by two in the above and below portions, and the separation board 6 is connected to the duct main body 50 by sandwiching the duct main body 50 of the duct 5 between the openings formed in the attaching portions 62.

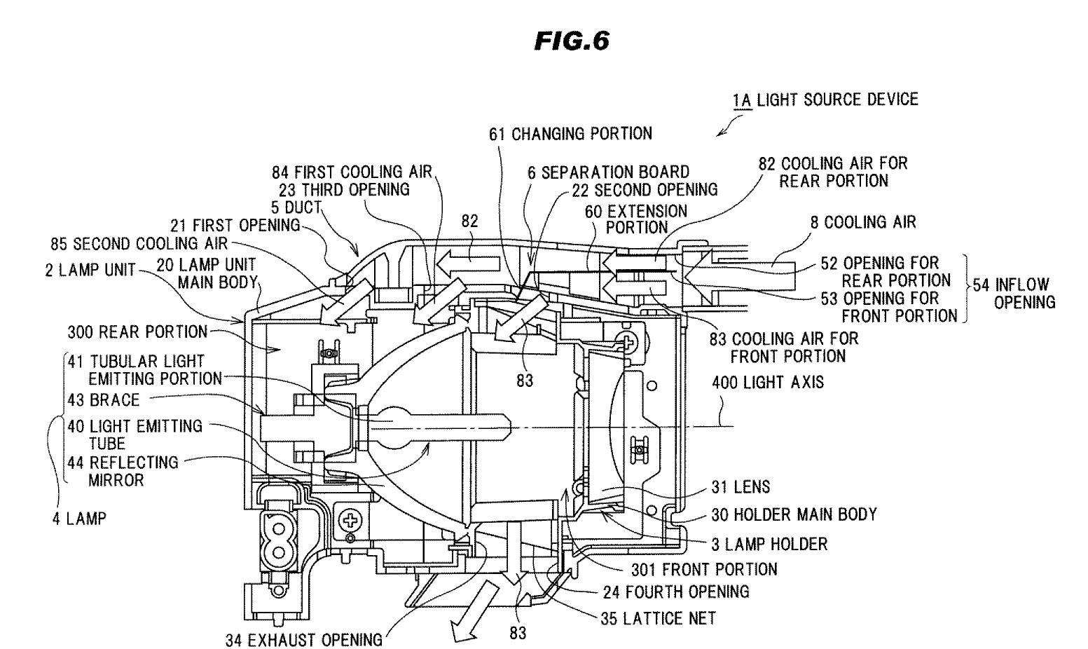

FIG. 6 is a plan view showing a light source device according to a first embodiment of the invention. FIG. 6 shows flow paths through which the cooling air 9 is sucked into and exhausted from the lamp unit 2.

The electric-powered fan 7 is disposed in the side surface of the lamp 4 and in a position anterior to the lamp 4, as one example has blades 70 to rotate by a motor (not shown) in a rotation direction 71 shown in FIG. 2, when the blades 70 rotate in the rotation direction 71, it sucks the cooling air 8 from near the center of rotation of the blades 70 and blows out the cooling air 8 to the inflow opening 54.

Since the electric-powered fan 7 is disposed in a position anterior to the lamp 4, the changing portion 61 can hit the cooling air 8 directly to the tubular light emitting portion 41 surrounded by the reflecting mirror 44 only by slightly changing the flow direction of the cooling air 8 being fed.

Further, the cooling portion is not limited to the electric-powered fan 7, and a cooling device to feed a cooled air can be also used. The electric-powered fan 7 used in the present embodiment has a structure that feeds the cooling air 8, but a fan having a structure that sucks the air in the front portion 301 by being installed in the side of the exhaust opening 34 can be also used, and not limited to these structures.

### (Operation)

Hereinafter, an operation of a projector used in the embodiment of the invention will be explained in detail with reference to the drawings.

When electric power supply of the projector 1 is turned on, the electric-powered fan 7 and the lamp 4 are supplied electric power.

The electric-powered fan 7 starts to rotate according to the supply of the electric-power, and as shown in FIG. 6, feeds the cooling air 8 to the inflow opening 54.

As shown in FIG. 6, the cooling air 8 flows in a direction of arrow shown in FIG. 6, being divided into the cooling air for rear portion 82 flowing into the opening for rear portion 52 and the cooling air for front portion 83 flowing into the opening for front portion 53 by the extension portion 60 of the separation board 6. At this time, the cooling air 8 flows from a wide opening to a narrow opening so that it is increased in the wind speed.

The cooling air for rear portion 82 is fed from the opening for rear portion 52, and flows along the extension portion 60 and from right direction to left direction in FIG. 6, and a part of it flows from the blowout opening 55 of the duct 5 to the third opening 23 of the lamp unit 2 and blows out to the rear side of the reflecting mirror 44 of the lamp 4 as a first cooling air 84.

Further, the remaining part of the cooling air for rear portion 82 flows from the blowout opening 55 of the duct 5 to the first opening 21 of the lamp unit 2 and blows out to the rear portion 300 of the lamp 4 as a second cooling air 85. Therefore, the rear portion 300 can be cooled by the first and second cooling airs 84, 85.

On the other hand, the cooling air for front portion 83 fed from the opening for front portion 53, after being fed from the opening for front portion 53, flows along the extension portion 60 from right direction to left direction in FIG. 6, and is changed about the flow direction in a direction of the light emitting tube 40 of the lamp 4 by the changing portion 61, and blows out to the front portion 301 through the blowout opening 55 of the duct 5, the second opening 22 and the lattice net 33.

As shown in FIG. 6, at this time, the cooling air for front portion 83 is changed about the flow direction of in a direction of the tubular light emitting portion 41 of the lamp 4 by the changing portion 61 and hits to the tubular light emitting portion 41 so as to cool the highest temperature point 46 and the lowest temperature point 47 as the upper cooling air 80 (refer to FIG. 4) and the lower cooling air 81 (refer to FIG. 4)

As shown in FIG. 6, the upper cooling air 80( refer to FIG. 4) and the lower cooling air 81 (refer to FIG. 4), after cooling the light emitting tube 40, is exhausted from the exhaust opening 34 through the fourth opening 24 of the lamp unit 2 and the lattice net 35, and the lamp 4 can maintain the desired temperature.

### (Advantages)

(1) According to a projector 1 using the first embodiment described above, the cooling air 8 can be divided into one for cooling the rear portion 300 of the lamp 4 and one for cooling the front portion 301 of the lamp 4 so that the lamp 4 can be effectively cooled.

(2) According to a projector 1 using the first embodiment described above, the cooling air 8 can be easily changed about the air volume fed to the rear portion 300 and the front portion 301 so that the design for obtaining the desired cooling effect can be simplified.

(3) According to a projector 1 using the first embodiment described above, the separation board 6 can be firmly fixed to the duct 5 so that occurrence of wind roar can be prevented.

(4) According to a projector 1 using the first embodiment described above, the duct 5 is easily installed and removed so that the separation board 6 can be easily replaced with a separating board being capable of obtaining the desired cooling effect, when there is a need for replacing the separation board 6, for example, since there are a large of varieties of the lamp 4 in the development of the other projector and the desired cooling effect is different from each other.

(5) According to a projector 1 using the first embodiment described above, the lamp 4 can be effectively cooled so that the number of rotations of the electric-powered fan can be decreased and further, the number of rotations be decreased so that working noise can be also decreased and electric power saving can be realized.

(6) According to a projector 1 using the first embodiment described above, the cooling air for rear portion 82 is further divided into the first cooling air 84 and the second cooling air 85 so as to cool the back portion of the reflecting mirror 44 and the rear portion 300 so that the lamp 4 can be more effectively cooled.

(7) According to a projector 1 using the first embodiment described above, the sizes of the opening for rear portion 52 and the opening for front portion 53 can be easily changed according to the mounting location the separation board 6 so that the design for obtaining the desired cooling effect can be simplified.

(8) According to a projector 1 using the first embodiment described above, the cooling air 8 is divided into the cooling air for rear portion 82 and the cooling air for front portion 83 by the extension portion 60 extending in a flow direction of the cooling air 8 fed from the electric-powered fan 7 so that it can be increased in the wind speed inside of the duct 5 so as to swiftly blow out through each opening.

### Second Embodiment

### (Construction)

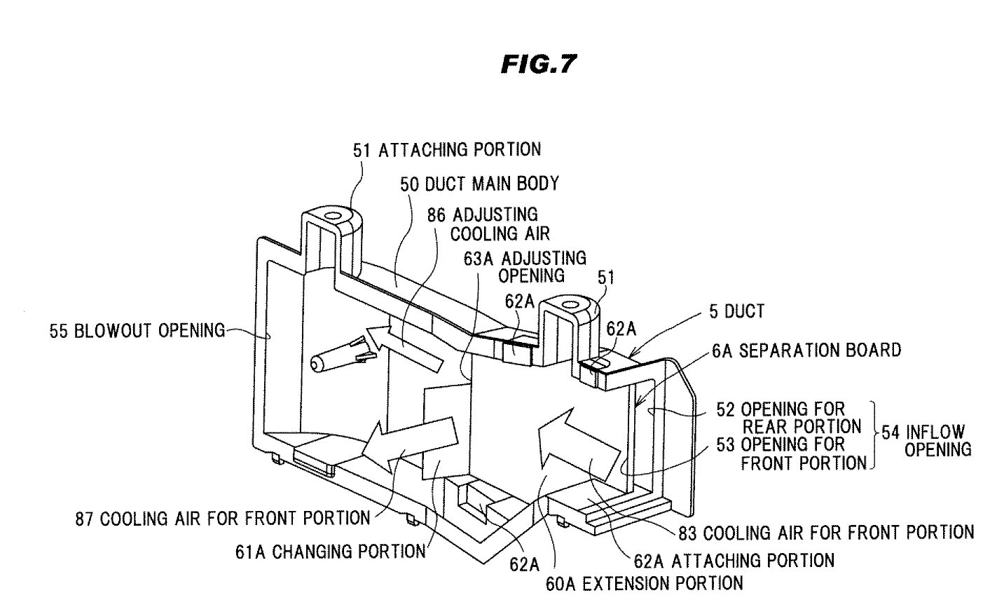

FIG. 7 is a schematic view showing a duct used in a light source device according to a second embodiment of the invention. The present embodiment differs in a structure of the separation board 6A from the first embodiment. Further, in the following description, with regard to components having the same construction and function as the first embodiment, the same references as the first embodiment are used, and detail explanation is omitted.

As shown in FIG. 7, the separation board GA in the present embodiment has an outline of structure that includes an extension portion 60A, a changing portion 61A, an attaching portion 62A, and an adjusting opening 63A. Further, the extension portion 60A and attaching portion 62A have the same structures as the portions 60, 62 of the first embodiment.

The changing portion 61A has a structure that includes an adjusting opening 63A at the top portion. As shown in FIG. 7, the adjusting opening 63A is adapted to feed a part of the cooling air for front portion 83 to the rear portion 300 as an adjusting cooling air 86.

### (Operation)

When the cooling air for front portion 87 for cooling the tubular light emitting portion 41 is required to be fine-adjusted, by adjusting the size of the adjusting opening 63A, the lamp 4 can be easily cooled to the desired temperature.

### (Advantage)

In addition to the advantages obtained by the first embodiment, according to a projector 1 using the second embodiment, the adjusting opening 63A is formed in the separation board 6A so that the tubular light emitting portion 41 can be fine-adjusted about the temperature so as to obtain the desired temperature. Further, the adjusting opening 63A can be adjusted for the purpose of adjusting the temperature of the rear portion 300.

### Third Embodiment

### (Construction)

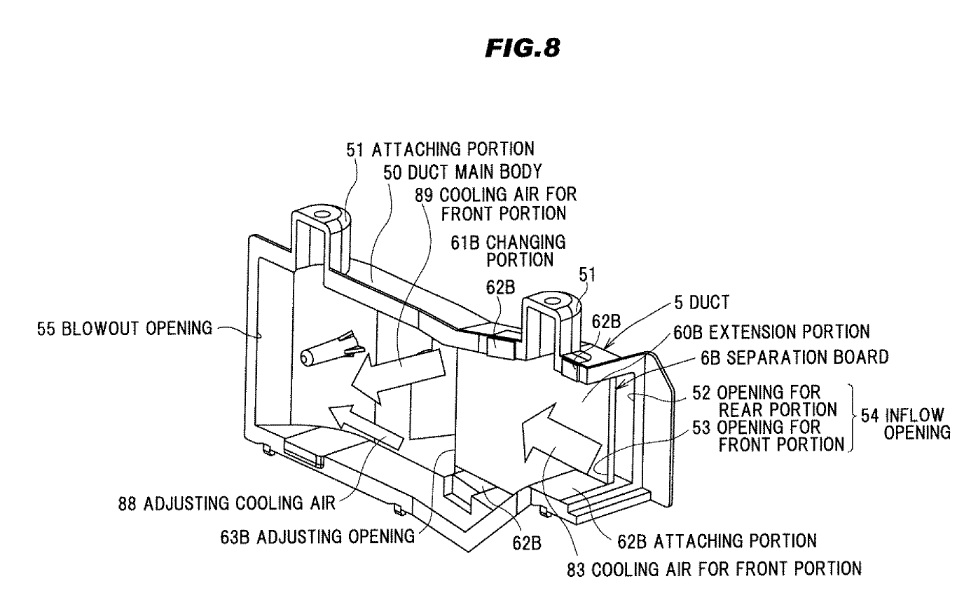

FIG. 8 is a schematic view showing a duct used in a light source device according to a third embodiment of the invention. The present embodiment differs in a structure of the separation board 6B from the first and second embodiments.

As shown in FIG. 8, the separation board 6B in the present embodiment has an outline of structure that includes an extension portion 60B, a changing portion 61B, an attaching portion 62B, and an adjusting opening 63B. Further, the extension portion 60B and attaching portion 62B have the same structures as the portions 60, 62 of the first embodiment.

The changing portion 61B has a structure that includes an adjusting opening 63B at the bottom portion. As shown in FIG. 8, the adjusting opening 63B is adapted to feed a part of the cooling air for front portion 83 to the rear portion 300 as an adjusting cooling air 83.

### (Operation)

When the cooling air for front portion 89 for cooling the light emitting tube 40 is required to be fine-adjusted, by adjusting the size of the adjusting opening 63B, the lamp 4 can be easily cooled to the desired temperature.

Further, when the cooling air for front portion 83 blowing out to the highest temperature point 46 and the lowest temperature point 47 of the tubular light emitting portion 41 shown in FIG. 4 is required to be adjusted, so as to further decrease the temperature of the highest temperature point 46 or to further increase the temperature of the lowest temperature point 47, the adjusting opening can be formed for fine-adjustment at the bottom portion as the adjusting opening 63B described in the third embodiment, and when the cooling air for front portion 83 is required to be adjusted so as to further increase the temperature of the highest temperature point 46 or to further decrease the temperature of the lowest temperature point 47, the adjusting opening can be formed for fine-adjustment at the bottom portion as the adjusting opening 63A described in the second embodiment.

Further, for example, when the projector 1 is installed on a ceiling, the highest temperature point 46 and the lowest temperature point 47 of the lamp 4 shown in FIG. 4 of the lamp 4 are turned upside down since the direction of gravitational force 9 acts on the projector 1 inversely.

Thus, as one example, by selecting any one of the separation boards 6, 6A, 6B shown in the first to third embodiments appropriately, the most qualified structure according to the installation condition can be easily designed.

### (Advantage)

According to a projector 1 using the third embodiment, by forming the adjusting opening 63B in the separation board 6B, the temperature of the tubular light emitting portion 41 can be fine-adjusted so as to obtain the desired temperature so that design freedom can be increased.

The location of the adjusting openings 63A, 63B described above is not limited to the top or bottom portion, for example, they can be formed at the central portion of the changing portion 61.

It is noted that the present invention is not limited to the embodiments described above and various changes can be made without departing from or changing the technical idea of the present invention.

What is claimed is:

1. A light source device, comprising:
a light emitting source;
a cooling portion to feed a cooling air for cooling the light emitting source;
a duct comprising an inflow opening through which the cooling air inflows; and
a separating portion installed in the duct, and being adapted to separate the duct and form an opening for front portion through which the cooling air blows out to the front portion of light emitting source and an opening for rear portion through which the cooling air blows out to the rear portion of light emitting source.

2. The light source device according to claim 1, wherein:
the light emitting source comprises a light emitting portion to emit a light, and a reflecting mirror installed so as to enclose the light emitting portion and reflect the light emitted from the light emitting portion in the direction of the light axis, and the opening for front portion is adapted to allow the cooling air to blows out through the opening so as to cool the light emitting portion.

3. The light source device according to claim 2, wherein:
the light emitting source comprises a mercury lamp.

4. The light source device according to claim 2, wherein:
the separating portion comprises an extension portion extending in the direction of the cooling air inflowing, and a changing portion installed at the end of the extension portion so as to change the direction of the cooling air which flows along the extension portion.

5. The light source device according to claim 4, wherein:
the changing portion comprises an adjusting opening to adjust the volume of cooling air to blow out through the opening for front portion and the place of light emitting portion to be cooled.

6. The light source device according to claim 4, wherein:
the cooling portion is located at the lateral part of, and in a position anterior to the light emitting source, and the changing portion is adapted to change the direction of the cooling air fed from the cooling portion to the direction of light emitting portion enclosed by the reflecting mirror.

7. The light source device according to claim 6, wherein:
the changing portion is adapted to change the direction of the cooling air so as to cool the highest temperature point and the lowest temperature point of the light emitting portion.

8. The light source device according to claim 5, wherein:
the changing portion is adapted to adjust the cooling air blowing out to the highest temperature point and the lowest temperature point by the adjusting opening.

9. The light source device according to claim 1, wherein:
the separating portion comprises an attaching portion for being attached to the duct.

10. The light source device according to claim 1, wherein:
the separating portion comprises a metallic material.

11. The light source device according to claim 1, wherein:
the cooling portion comprises an electric-powered fan.

12. The light source device according to claim 1, wherein:
the light source device is adapted to be mounted on a projector to project picture images onto a screen.

13. A light source device, comprising:
a light emitting source comprising a light emitting portion to emit a light, and a reflecting mirror installed so as to enclose the light emitting portion and reflect the light emitted from the light emitting portion in the direction of the light axis;
an electric-powered fan being located at the lateral part of, and in a position anterior to the light emitting source, and being adapted to feed a cooling air for cooling the light emitting source;
a duct comprising an inflow opening through which the cooling air inflows, and
a separating portion installed in the duct, being adapted to separate the duct and form an opening for front portion through which the cooling air blows out so as to cool the light emitting portion from the front portion of light emitting source and an opening for rear portion through which the cooling air blows out so as to cool the reflecting mirror and the rear portion of light emitting source, and comprising an extension portion extending in the direction of the cooling air inflowing, and a changing portion installed at the end of the extension portion so as to change the direction of the cooling air which flows along the extension portion.

14. The light source device according to claim 13, wherein:
the light emitting source comprises a mercury lamp.

15. The light source device according to claim 13, wherein:
the changing portion comprises an adjusting opening to adjust the volume of cooling air to blow out through the opening for front portion and the place of light emitting portion to be cooled.

16. The light source device according to claim 15, wherein:
the changing portion is adapted to adjust the cooling air blowing out to the highest temperature point and the lowest temperature point by the adjusting opening.

17. The light source device according to claim 13, wherein:
the changing portion is adapted to change the direction of the cooling air so as to cool the highest temperature point and the lowest temperature point of the light emitting portion.

18. The light source device according to claim 13, wherein:
the separating portion comprises an attaching portion for being attached to the duct.

19. The light source device according to claim 13, wherein:
the separating portion comprises a metallic material.

20. The light source device according to claim 12, wherein:
the light source device is adapted to be mounted on a projector to project picture images onto a screen.
